(19) United States
(12) Patent Application Publication
(10) Pub. No.: US 2012/0138205 A1
(43) Pub. Date: Jun. 7, 2012

(54) PNEUMATIC TIRE

(75) Inventor: Kazuo Shimomura, Osaka (JP)

(73) Assignee: TOYO TIRE & RUBBER CO., LTD., Osaka (JP)

(21) Appl. No.: 13/307,309

(22) Filed: Nov. 30, 2011

(30) Foreign Application Priority Data
Dec. 2, 2010 (JP) 2010-269559
Dec. 2, 2010 (JP) 2010-269566

(51) Int. Cl. B60C 9/18

(52) U.S. Cl. 152/535

(57) ABSTRACT

A pneumatic tire has a belt layer arranged in a tread portion. The belt layer includes a first belt ply, a second belt ply arranged in an outer peripheral side of the first belt ply, and a third belt ply arranged in an outer peripheral side of the second belt ply. The third belt ply is provided with a circumference reinforcing portion which is positioned in an inner region of a land portion, and a lateral reinforcing portion which is positioned in an inner region of a main groove. The circumference reinforcing portion is structured such that an angle of a cord with respect to a tire circumferential direction is less than 45°. The lateral reinforcing portion is structured such that an angle of a cord with respect to the tire circumferential direction goes beyond 45°.

### BACKGROUND OF THE INVENTION

1. Field of the Invention

The present invention relates to a pneumatic tire in which a belt layer is arranged in an outer peripheral side of a carcass layer in a tread portion, and a surface of the tread portion is provided with a main groove which extends along a tire circumferential direction and a land portion which is sectioned thereby.

2. Description of the Related Art

Generally, a main groove extending along a tire circumferential direction is formed on a surface of a tread portion of a pneumatic tire, and a land portion is sectioned into a plurality of sections by the main groove. As a result of the intensive study by the present inventor, there has been known that a force called an in-plane shrinkage force acts within a contact surface in a state in which the tire is grounded, and a deformation of the land portion due to the force has an adverse effect on a wear performance more than a little. In the present specification, the deformation of the land portion mentioned above is called a wiping deformation.

At the time of a general traveling, the wiping deformation mentioned above is combined with a local deformation going with a leading at the time of a tire rolling, a generation of a heel and toe wear in which an amount of wear is different in a leading side and a trailing side of the land portion is promoted, and a shortening of a wear life is further caused. In conjunction with it, an in-plane shrinkage force in a tire width direction having a base point in a groove bottom tends to be applied to a forming position of the main groove in which a rubber runs short, and a generation of an irregular wear such as a center wear or a shoulder wear is promoted.

Further, since the in-plane shrinkage force acts toward a center portion from a peripheral edge of the contact surface, and a stronger force acts in accordance with coming close to the peripheral edge, the wiping deformation along the tire circumferential direction becomes predominant in the center side in the tread width direction, and the wiping deformation along the tire width direction becomes predominant in both end sides in the tread width direction. In accordance with this, an early progress of the wear is promoted and the generation of the irregular wear such as the center wear, the shoulder wear or the heel and toe wear is promoted.

Japanese Unexamined Utility Model Publication No. 3-123702 describes a pneumatic tire in which a reinforcing layer (a cap layer) is arranged in an inner region of a rib corresponding to a land portion, and Japanese Unexamined Patent Publication No. 20θ8-285059 describes a pneumatic tire in which a reinforcing layer (an additional protection layer) is arranged in an inner region of a main groove. However, in these tires, since a cord included in the reinforcing layer extends uniformly in a tire circumferential direction or an angle which is close thereto, it is impossible to suppress a wiping deformation along a tire width direction, and it is thought that an effect of improving the wear performance is poor in the light of the point of view mentioned above.

### SUMMARY OF THE INVENTION

The present invention has been made in view of the above circumstances, and an object of the present invention is to provide a pneumatic tire which can improve a wear performance by suppressing a wiping deformation caused by an in-plane shrinkage force at the time of grounding.

The object can be achieved by the following present invention. That is, a first aspect of the present invention provides a pneumatic tire comprising a belt layer arranged in an outer peripheral side of a carcass layer in a tread portion, a main groove extending along a tire circumferential direction, a land portion sectioned by the main groove, and the main groove and the land portion being provided in a surface of the tread portion, wherein the belt layer includes a first belt ply, a second belt ply arranged in an outer peripheral side of the first belt ply, and a third belt ply arranged in an outer peripheral side of the second belt ply, and wherein the third belt ply is provided with a circumference reinforcing portion which is positioned in an inner region of the land portion and is structured such that an angle of a cord with respect to a tire circumferential direction is less than 45°, and a lateral reinforcing portion which is positioned in an inner region of the main groove and is structured such that an angle of a cord with respect to the tire circumferential direction goes beyond 45°.

In the pneumatic tire, since the belt layer includes the third belt ply as mentioned above, and has the circumference reinforcing portion in which the cord extends in the tire circumferential direction or at the angle close thereto in the inner region of the land portion, it is possible to suppress the wiping deformation along the tire circumferential direction which causes the heel and toe wear. Further, since has the lateral reinforcing portion in which the cord extends in the tire width direction or at the angle close thereto in the inner region of the main groove, it is possible to suppress the wiping deformation caused by the in-plane shrinkage force in the tire width direction having the base point in the groove bottom of the main groove. As a result, it is possible to suppress the wiping deformation caused by the in-plane shrinkage force at the time of grounding so as to improve the wear performance.

In the pneumatic tire in accordance with the first aspect of the present invention, it is preferable that the angle of the cord with respect to the tire circumferential direction in the circumference reinforcing portion is between 0 and 20°, and the angle of the cord with respect to the tire circumferential direction in the lateral reinforcing portion is between 55 and 90°. In accordance with the structure mentioned above, since it is easy to suppress the wiping deformation along the tire circumferential direction by making the angle of the cord of the circumference reinforcing portion closer to the tire circumferential direction, and it is easy to suppress the wiping deformation caused by the in-plane shrinkage force in the tire width direction by making the angle of the cord of the lateral reinforcing portion closer to the tire width direction, it is possible to enhance the effect of improving the wear performance mentioned above.

In the pneumatic tire in accordance with the first aspect of the present invention, it is preferable that the cord constructing the third belt ply is made of steel. In accordance with the structure mentioned above, it is possible to enhance the effect of suppressing the wiping deformation by setting the cord of the third belt ply to the high strength.

Further, a second aspect of the present invention provides a pneumatic tire comprising a belt layer arranged in an outer peripheral side of a carcass layer in a tread portion, wherein the belt layer includes a first belt ply, a second belt ply arranged in an outer peripheral side of the first belt ply, and a third belt ply arranged in an outer peripheral side of the second belt ply, and wherein the third belt ply is provided with a center reinforcing portion which is positioned in a center side in a tread width direction and is structured such that an angle of a cord with respect to a tire circumferential direction is less than 45°, and a shoulder reinforcing portion which is positioned in both end sides in the tread width direction and is structured such that an angle of a cord with respect to the tire circumferential direction goes beyond 45°.

Since the pneumatic tire includes the third belt ply as mentioned above in the belt layer, is provided with the center reinforcing portion in which the cord extends in the tire circumferential direction or at the angle close thereto, in the center side in the tread width direction in which the wiping deformation along the tire circumferential direction becomes predominant, and is provided with the shoulder reinforcing portion in which the cord extends in the tire width direction or at the angle close thereto, in both end sides in the tread width direction in which the wiping deformation along the tire width direction becomes predominant, it is possible to improve the wear performance by suppressing the wiping deformation caused by the in-plane shrinkage force at the time of grounding.

In the pneumatic tire in accordance with the second aspect of the present invention, it is preferable that the angle of the cord with respect to the tire circumferential direction in the center reinforcing portion is between 0 and 35°, and the angle of the cord with respect to the tire circumferential direction in the shoulder reinforcing portion is between 70 and 90°. In accordance with the structure mentioned above, since it is easy to suppress the wiping deformation in the center side in the tread width direction by making the angle of the cored of the center reinforcing portion closer to the tire circumferential direction, and it is easy to suppress the wiping deformation in both end sides in the tread width direction by making the angle of the cord of the shoulder reinforcing portion closer to the tire width direction, it is possible to effectively improve the wear performance.

In the pneumatic tire in accordance with the second aspect of the present invention, it is preferable that the shoulder reinforcing portion is arranged in a region reaching an inner region of a shoulder main groove which is positioned in an outermost side in the tread width direction formed in a tread surface, from an end portion of the third belt ply. Since the in-plane shrinkage force in the tire width direction having the base point in the groove bottom is apt to act on the forming position of the main groove because of the lack of the rubber, and the tendency is particularly significant in the shoulder main groove positioned in the outermost side, it is possible to effectively suppress the wiping deformation along the tire width direction by the shoulder reinforcing portion, in accordance with the structure mentioned above.

In the pneumatic tire in accordance with the second aspect of the present invention, it is preferable that the cord constructing the third belt ply is made of steel. In accordance with the structure mentioned above, it is possible to enhance the effect of suppressing the wiping deformation by setting the cord of the third belt ply to the high strength.

### BRIEF DESCRIPTION OF THE DRAWINGS

FIG. 1 is a tire meridian cross sectional view showing one example of a tread portion of a pneumatic tire in accordance with a first aspect of the present invention;

FIG. 2 is a plan view of a belt layer provided in the tire in FIG. 1;

FIG. 3 is a cross sectional view showing a periphery of a main groove of the tire in FIG. 1;

FIG. 4 is a tire meridian cross sectional view showing one example of a tread portion of a pneumatic tire in accordance with a second aspect of the present invention;

FIG. 5 is a plan view of a belt layer provided in the tire in FIG. 4;

FIG. 6 is a cross sectional view showing a periphery of a shoulder main groove of the tire in FIG. 4;

### DETAILED DESCRIPTION OF PREFERRED EMBODIMENTS

An embodiment of the present invention will be explained with reference to the drawings.

First Aspect

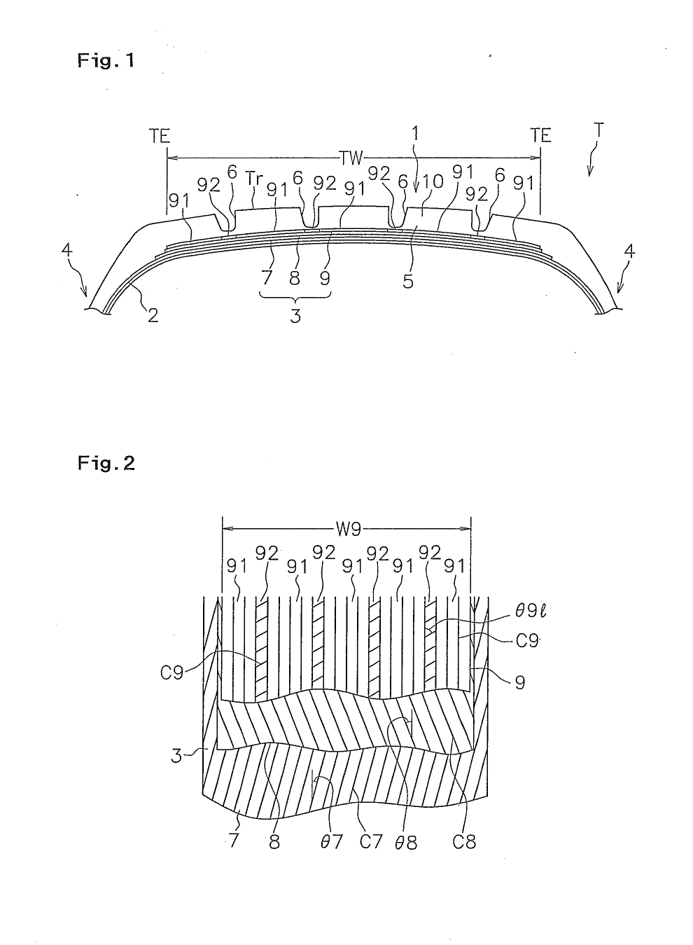

A tire T shown in FIG. 1 is a pneumatic radial tire for a pickup truck, and a belt layer 3 is arranged in an outer peripheral side of a carcass layer 2 in a tread portion 1. The carcass layer 2 is constructed by a toroidal shaped carcass ply including a cord which extends approximately vertically to a tire circumferential direction, and runs into the tread portion 1 from a pair of bead portions (not shown) via a side wall portion 4 so as to construct a framework of the tire.

The belt layer 3 is laminated on an outer periphery of the carcass layer 2, and reinforces the carcass layer 2 on the basis of a hoop effect. A tread rubber 5 is provided in an outer peripheral side of the belt layer 3, and an outer peripheral surface of the tread rubber 5, that is, a surface of the tread portion 1 comes to a tread surface Tr. The tread surface Tr is provided with a plurality of (four in the present embodiment) main grooves 6 which extend along the tire circumferential direction, and a land portion 10 which is sectioned by them. The land portion 10 in accordance with the present embodiment is constructed by a plurality of blocks which are segmented by lateral grooves (not shown).

The belt layer 3 includes a belt ply 7 (a first belt ply), a belt ply 8 (a second belt ply) which is arranged in an outer peripheral side of the belt ply 7, and a belt ply 9 (a third belt ply) which is arranged in an outer peripheral side of the belt ply 8. In the present embodiment, the belt ply 7 is laminated in an outer periphery of the carcass layer 2, the belt ply 8 is laminated in an outer periphery of the belt ply 7, and the belt ply 9 is laminated in an outer periphery of the belt ply 8. Each of the belt plies includes a plurality of cords which are arranged in parallel like a bamboo blind, and is formed by coating them with a rubber.

FIG. 2 is a plan view of the belt layer 3, the cord in the drawing is conceptually described, and an actual arrangement pitch is denser. The belt plies 7 and 8 respectively include cords C7 and C8 which extend while inclining at angles of θ7 and θ8 with respect to the tire circumferential direction (a vertical direction in FIG. 2), and are arranged in such a manner that the cords C7 and C8 intersect inversely to each other. The angle θ7 and θ8 are set, for example, between 15° and 35°.

The belt ply 9 is provided with a circumference reinforcing portion 91 which is positioned in an inner region of the land portion 10 and is structured such that an angle θ9c of a cord C9 with respect to the tire circumferential direction becomes less than 45°, and a lateral reinforcing portion 92 which is positioned in an inner region of the main groove 6 and is structured such that an angle θ91 of the cord C9 with respect to the tire circumferential direction goes beyond 45°. In the present embodiment, there is shown an example in which the angle θ9c is 0°. The belt ply 9 is closest to the land portion 10 among the belt plies constructing the belt layer 3, and greatly contributes to a suppression of the wiping deformation.

As mentioned above, in the belt ply 9, the cord C9 extends in the tire circumferential direction or at the angle close thereto, at a position corresponding to the land portion 10 in which there is fear that the heel and toe wear is generated, and the cord C9 extends in the tire width direction or at the angle close thereto, at a position corresponding to the main groove 6 on which the in-plane shrinkage force in the tire width direction having the base point in the groove bottom is apt to act. In accordance with the structure mentioned above, it is possible to suppress the wiping deformation caused by the in-plane shrinkage force at the time of grounding so as to improve the wear performance.

In order to enhance the effect of suppressing the wiping deformation, the angle θ9c of the cord C9 in the circumference reinforcing portion 91 is preferably between 0° and 20°, and more preferably between 0° and 15°. Further, the angle θ91 of the cord C9 in the lateral reinforcing portion 92 is preferably between 55° and 90°, and more preferably between 80° and 90°. In the case that the cord C9 of the circumference reinforcing portion 91 is inclined with respect to the tire circumferential direction (in other words, in the case of θ9c>0°), it is preferable that the directions of incline are made identical between the circumference reinforcing portion 91 and the lateral reinforcing portion 92, whereby it is possible to suppress a rigidity change within the same block and it is beneficial in the light of an irregular wear performance.

A width W9 of the belt ply 9 is preferably set to 70 to 110% of a contact width TW. If this is less than 70%, the belt ply 9 becomes narrow, and the effect of improving the wear performance by suppressing the wiping deformation tends to be lowered. Further, it goes beyond 110%, the belt ply 9 becomes wide, and a useless portion which does not contribute to the suppression of the wiping deformation within the contact surface is increased. In the light of appropriately suppressing the wiping deformation within the contact surface, the width W9 is more preferably set to 90 to 100% of the contact width TW.

A contact end TE indicates an outermost position in a tire axial direction which grounds on a road surface at the time of putting the tire on a flat road surface vertically in a state of being assembled in a normal rim and being filled with a normal internal pressure, and applying a normal load. A distance in the tire axial direction between the contact ends TE comes to a contact width TW. The normal load and the normal internal pressure are a maximum load (a design normal load in the case of a tire for a passenger car) which is defined in JISD4202 (data of an automobile tire) or the like, and a pneumatic pressure corresponding thereto. The normal rim is a standard rim which is defined in JISD4202 or the like as a general rule. The width W9 is determined under the same condition.

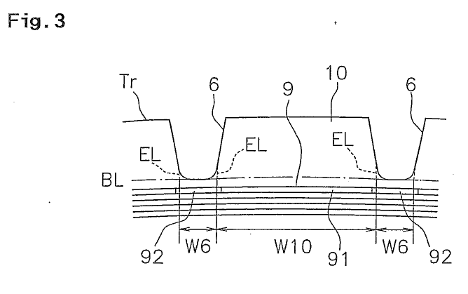

In the light of preventing the generation of the heel and toe wear by sufficiently securing the effect of suppressing the wiping deformation by the circumference reinforcing portion 91, it is preferable that the circumference reinforcing portion 91 captures a region which is equal to or more than 70% of the width W10 of the land portion 10 at the time of projecting the circumference reinforcing portion 91 on a groove bottom height BL of the main groove 6 shown in FIG. 3. The width W10 is measured on the groove bottom height BL on the basis of an extension line EL of the groove wall of the main groove 6. The groove bottom height BL is a height at which a deepest end of the main groove 6 is positioned, and extends at the same curvature as a tread surface Tr.

Further, in the light of sufficiently suppressing the wiping deformation caused by the in-plane shrinkage force having the base point in the groove bottom of the main groove 6, it is preferable that the lateral reinforcing portion 92 captures a region which is equal to or more than 160% of the groove width W6 of the main groove 6, at the time of projecting the lateral reinforcing portion 92 on the groove bottom height BL of the main groove 6. This matter is the same in the other main grooves 6. The groove width W6 is measured on the groove bottom height BL on the basis of the extension line EL of the groove wall of the main groove 6.

In the present embodiment, the belt ply 9 is laminated on the outer periphery of the belt ply 8 in such a manner as to easily form the tread portion 1. However, it is possible to enhance the action of suppressing the wiping deformation by offsetting the belt ply 9 to the tread surface Tr side without being limited to this. In this case, it is sufficient that the belt ply 9 is buried in the vicinity of the groove bottom height BL. Since an interface between a cap rubber and a base rubber is formed at the same height as the groove bottom height BL as long as a general tread rubber having a cap and base structure, the belt ply 9 may be interposed in the interface.

It is preferable that the cords C7 and C8 included in the belt plies 7 and 8 are made of steel in order to enhance a reinforcing effect with respect to the carcass layer 2. Further, even in the cord C9 included in the belt ply 9, in the light of enhancing the effect of suppressing the wiping deformation, it is preferable that it is made of the steel, and may be made of another material having a corresponding strength to the steel.

In the present embodiment, there is shown an example in which an end portion of the lateral reinforcing portion 92 is connected to an end portion of the circumference reinforcing portion 91, however, they may be separated. In the case that both the reinforcing portions are connected as in the present embodiment, the end portions of the circumference reinforcing portion 91 and the lateral reinforcing portion 92 which are prepared independently may be confronted to each other so as to be pressure connected by a zipper joint or the like, or the end portions may be overlapped so as to be bonded in such a manner that the cords do not overlap with each other.

The pneumatic tire in accordance with the first aspect of the present invention is the same as the normal pneumatic tire except the matter that the belt layer is provided with the third belt ply as mentioned above, and all of the material, the shape, the structure, the manufacturing method and the like which are conventionally known can be employed in the present invention.

Second Aspect

Since it has the same structure as the embodiment in the first aspect except the structure described below, a common point with the embodiment mentioned above will be omitted, and a different point will be mainly described. The same reference numerals are attached to the same members and positions as the members and positions described in the embodiment mentioned above, and an overlapping description will not be repeated.

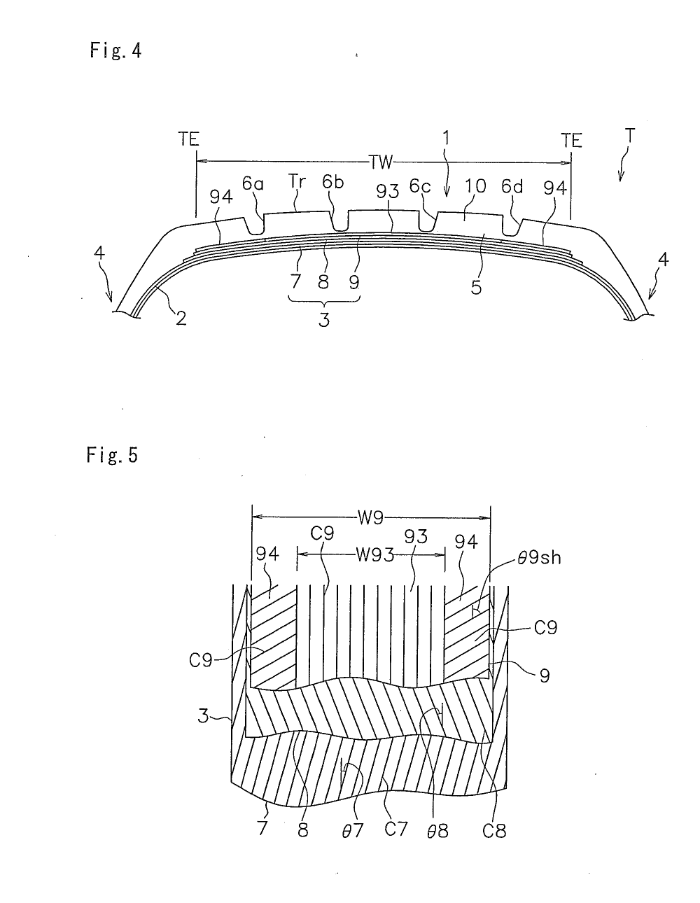

A tire T shown in FIG. 4 is a pneumatic radial tire for a pickup truck, and a belt layer 3 is arranged in an outer peripheral side of a carcass layer 2 in a tread portion 1. The tread surface Tr is provided with a plurality of (four in the present embodiment) main grooves 6a to 6d which extend along the tire circumferential direction, and a land portion 10 which is sectioned by them. The land portion 10 in accordance with the present embodiment is constructed by a plurality of blocks which are segmented by lateral grooves (not shown).

The belt layer 3 includes a belt ply 7 (a first belt ply), a belt ply 8 (a second belt ply) which is arranged in an outer peripheral side of the belt ply 7, and a belt ply 9 (a third belt ply) which is arranged in an outer peripheral side of the belt ply 8. As shown in FIG. 5, the belt plies 7 and 8 respectively include cords C7 and C8 which extend while inclining at angles of θ7 and θ8 with respect to the tire circumferential direction. The angle θ7 and θ8 are set, for example, between 15° and 35°.

The belt ply 9 is provided with a center reinforcing portion 91 which is positioned in a center side in the tread width direction and is structured such that an angle θ9ce of the cord C9 with respect to the tire circumferential direction is less than 45°, and a shoulder reinforcing portion 92 which is positioned in both end sides in the tread width direction and is structured such that an angle θ9sh of the cord C9 with respect to the tire circumferential direction goes beyond 45°. In the present embodiment, there is shown an example in which the angle θ9ce is 0°. The belt ply 9 is closest to the land portion 10 among the belt plies constructing the belt layer 3, and greatly contributes to a suppression of the wiping deformation.

As mentioned above, in the belt ply 9, the cord C9 extends in the tire circumferential direction or at the angle close thereto, in the center side in the tread width direction in which the wiping deformation along the tire circumferential direction becomes predominant, and the cord C9 extends in the tire width direction or at the angle close thereto, in the both end sides in the tread width direction in which the wiping deformation along the tire width direction becomes predominant. In accordance with the structure mentioned above, it is possible to improve the wear performance by suppressing the wiping deformation caused by the in-plane shrinkage force at the time of grounding.

In order to enhance the effect of suppressing the wiping deformation, the angle θ9ce of the cord C9 in the center reinforcing portion 91 is preferably between 0° and 35°, and more preferably between 0° and 15°. Further, the angle θ9sh of the cord C9 in the shoulder reinforcing portion 92 is preferably between 70° and 90°, and more preferably between 80° and 90°. In the case that the cord C9 of the center reinforcing portion 91 is inclined with respect to the tire circumferential direction (in other words, in the case of θ9ce>0°), it is preferable to make the directions of incline identical between the center reinforcing portion 91 and the shoulder reinforcing portion 92, whereby it is possible to suppress a rigidity difference between the center side and both end sides and it is beneficial in the light of an irregular wear performance in the tire width direction.

The in-plane shrinkage force in the tire width direction having the base point in the groove bottom is apt to act on the forming position of the main grooves 6a to 6d because of the lack of the rubber, and the tendency is particularly significant in the shoulder main grooves 6a and 6d positioned in the outermost side in the tread width direction. Accordingly, in the present embodiment, the shoulder reinforcing portion 92 is arranged in the region which reaches the inner region of the shoulder main grooves 6a and 6d from the end portion of the belt ply 9, whereby it is possible to effectively suppress the wiping deformation along the tire width direction by the shoulder reinforcing portion 92.

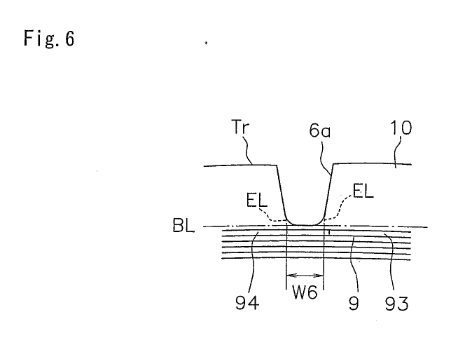

In the light of sufficiently suppressing the wiping deformation having the base point in the groove bottom of the shoulder main groove 6a, it is preferable that the shoulder reinforcing portion 92 captures a region which becomes equal to or more than 250% of the groove width W6 of the main groove 6a, at the time of projecting the shoulder reinforcing portion 92 on the groove bottom height BL of the main groove shown in FIG. 6. This matter is the same in the shoulder main groove 6d. The groove width W6 is measured on the groove bottom height BL on the basis of the extension line EL of the groove wall.

A width W91 of the center reinforcing portion 91 is preferably set to 40 to 70% of a contact width TW. Since this is equal to or more than 40%, the wiping deformation along the tire circumferential direction is appropriately suppressed, and it becomes beneficial for preventing the generation of the heel and toe wear and the prevention of the early progress of the wear. Further, since it is equal to or less than 70%, the arranged region of the shoulder reinforcing portion 92 is secured, the wiping deformation along the tire width direction is appropriately suppressed by the shoulder reinforcing portion 92, and it becomes beneficial for preventing the generation of the center wear and the shoulder wear.

It is preferable that the cords C7 and C8 included in the belt plies 7 and 8 are made of steel in order to enhance a reinforcing effect with respect to the carcass layer 2. Further, even in the cord C9 included in the belt ply 9, in the light of enhancing the effect of suppressing the wiping deformation, it is preferable that it is made of the steel, and may be made of another material having a corresponding strength to the steel.

In the present embodiment, there is shown an example in which an end portion of the shoulder reinforcing portion 92 is connected to an end portion of the center reinforcing portion 91, however, they may be separated. In the case that both the reinforcing portions are connected as in the present embodiment, the end portions of the center reinforcing portion 91 and the shoulder reinforcing portion 92 which are prepared independently may be confronted to each other so as to be pressure connected by a zipper joint or the like, or the end portions may be overlapped so as to be bonded in such a manner that the cords do not overlap with each other.

The pneumatic tire in accordance with the second aspect of the present invention is the same as the normal pneumatic tire except the matter that the belt layer is provided with the third belt ply as mentioned above, and all of the material, the shape, the structure, the manufacturing method and the like which are conventionally known can be employed in the present invention.

In order to specifically show the structure and the effect of the present invention, an evaluation of the wear performance as shown below was carried out, and it will be described.

(1) Wear Resistance (Wear Life)

After installing the tire to an actual car and traveling on a general road at 50000 km, an amount of wear (a reducing amount of the main groove depth) was measured in the center side and both end sides in the tread width direction, and an inverse number of a maximum value of the amount of wear was calculated. The evaluation is indicated by an index number in the case of setting a comparative example 1 to 100, and the greater numerical value indicates the more excellent performance.

(2) Irregular Wear Performance (Center Wear and Shoulder Wear)

In the tire after traveling mentioned above, a ratio (amount of center wear/amount of shoulder wear) between the amount of wear in the center side in the tread width direction (amount of center wear) and the amount of wear in both end sides (amount of shoulder wear) was measured. The closer ratio to 1.0 tends to a uniform wear, and indicates an excellent performance.

(3) Heel and Toe Wear Performance

In the tire after traveling mentioned above, heights in a leading side and a trailing side of a block corresponding to a land portion provided in the center side in the tread width direction were measured, and an inverse number of a difference of altitude was calculated. The evaluation is indicated by an index number in the case of setting a comparative example 1 to 100, and the greater numerical value indicates the more excellent performance.

In the tire (size LT265/70R17) of the structure shown in FIG. 1, a comparative example 1 was set to a structure in which the third belt ply includes a cord (made of nylon) which extends in parallel to the tire circumferential direction and uniformly, a comparative example 2 was set to a structure including a cord (made of steel) which extends at 45° with respect to the tire circumferential direction and uniformly, an example 1 was set to a structure in which the circumference reinforcing portion and the lateral reinforcing portion as shown in FIG. 2 were provided, and angles θ9c and θ9l of the cords (made of steel) included therein were set to 0° and 80° respectively, and an example 2 was set to a structure in which the center reinforcing portion and the shoulder reinforcing portion as shown in FIG. 5 were provided, and angles θ9ce and θ9sh of the cords (made of steel) included therein were set to 0° and 80° respectively. Results of evaluation are shown in Table 1.

TABLE 1

| | | Irregular wear | Heel and toe wear |
|---|---|---|---|
| | Wear resistance | performance | performance |
| Comparative | 100 | 1.50 | 100 |
| Example 1 | | | |
| Comparative | 105 | 1.35 | 97 |
| Example 2 | | | |
| Example 1 | 107 | 1.15 | 103 |
| Example 2 | 107 | 1.15 | 102 |

In the comparative example 1, since the suppression of the wiping deformation along the tire width direction is not sufficient, the irregular wear performance is comparatively low, and the wear resistance is inferior in conjunction with it. In the comparative example 2, since it is impossible to suppress both the wiping deformation along the tire circumferential direction and the wiping deformation along the tire width direction, the irregular wear performance and the heel and toe wear performance are inferior. On the contrary, in the example 1 and the example 2, the irregular wear performance and the heel and toe wear performance are comparatively excellent and the wear resistance can be improved.

What is claimed is:

1. A pneumatic tire comprising:
a belt layer arranged in an outer peripheral side of a carcass layer in a tread portion;
a main groove extending along a tire circumferential direction;
a land portion sectioned by the main groove; and
the main groove and the land portion being provided in a surface of the tread portion,
wherein the belt layer includes a first belt ply, a second belt ply arranged in an outer peripheral side of the first belt ply, and a third belt ply arranged in an outer peripheral side of the second belt ply, and
wherein the third belt ply is provided with a circumference reinforcing portion which is positioned in an inner region of the land portion and is structured such that an angle of a cord with respect to a tire circumferential direction is less than 45°, and a lateral reinforcing portion which is positioned in an inner region of the main groove and is structured such that an angle of a cord with respect to the tire circumferential direction goes beyond 45°.

2. The pneumatic tire according to claim 1, wherein the angle of the cord with respect to the tire circumferential direction in the circumference reinforcing portion is between 0 and 20°, and the angle of the cord with respect to the tire circumferential direction in the lateral reinforcing portion is between 55 and 90°.

3. The pneumatic tire according to claim 1, wherein the cord constructing the third belt ply is made of steel.

4. A pneumatic tire comprising:
a belt layer arranged in an outer peripheral side of a carcass layer in a tread portion,
wherein the belt layer includes a first belt ply, a second belt ply arranged in an outer peripheral side of the first belt ply, and a third belt ply arranged in an outer peripheral side of the second belt ply, and
wherein the third belt ply is provided with a center reinforcing portion which is positioned in a center side in a tread width direction and is structured such that an angle of a cord with respect to a tire circumferential direction is less than 45°, and a shoulder reinforcing portion which is positioned in both end sides in the tread width direction and is structured such that an angle of a cord with respect to the tire circumferential direction goes beyond 45°.

5. The pneumatic tire according to claim 4, wherein the angle of the cord with respect to the tire circumferential direction in the center reinforcing portion is between 0 and 35°, and the angle of the cord with respect to the tire circumferential direction in the shoulder reinforcing portion is between 70 and 90°.

6. A pneumatic tire according to claim 4, wherein the shoulder reinforcing portion is arranged in a region reaching an inner region of a shoulder main groove which is positioned in an outermost side in the tread width direction formed in a tread surface, from an end portion of the third belt ply.

7. The pneumatic tire according to claim 4, wherein the cord constructing the third belt ply is made of steel.
